(19) United States
(12) Patent Application Publication
(10) Pub. No.: US 2013/0264735 A1
(43) Pub. Date: Oct. 10, 2013

(54) MOLD-MAKING METHOD CAPABLE OF SHORTENING A PROCEDURE OF MANUFACTURING A PRODUCT MOLD

(71) Applicant: Kuang-Chu LAI, New Taipei City (TW)

(72) Inventor: Kuang-Chu LAI, New Taipei City (TW)

(73) Assignee: Liang Meng Plastic Share Co., Ltd.

(21) Appl. No.: 13/440,531

(22) Filed: Apr. 5, 2012

(51) Int. Cl. B29C 45/76; B29C 33/40

(52) U.S. Cl. 264/40.1; 264/219

(57) ABSTRACT

The present invention provides a mold-making method capable of shortening a procedure of manufacturing a product mold, including steps of: preparing a plastic original mold; processing the original mold to form a preliminary product; assembling the preliminary product and testing the functions of the preliminary product having the original mold; producing a standard mold after testing the functions of the preliminary product; and producing a final mold having a profile and a dimension corresponding to those of the standard mold. By this method, the procedure of developing a mold is shortened, so that the production cost of a mold can be reduced.

### BACKGROUND OF THE INVENTION

1. Field of the Invention

The present invention relates to mold-making, and in particular to a mold-making method capable of shortening a procedure of manufacturing a product mold.

2. Description of Prior Art

Modern electronic products or articles for daily use are almost provided with a plastic casing. In view of price competition, most of the plastic articles are made by an injection molding process, thereby conforming to the requirements for fast, repeatable and mass production as well as cheap price.

Conventionally, the dimension of a mold must be designed to correspond to outer and inner profiles of a desired final product. Before on sale, most of electronic devices have to be tested with regard to their strength, lifetime and anti-EMI property, thereby ascertaining the safety of the electronic products in use. Thus, after a product mold has been tested for several properties, the product mold often has to be modified and redesigned to conform to the requirements for a desired final product.

Since most of molds are made by steel materials in order to have a greater strength and longer lifetime, the steel materials cannot be processed easily. As a result, the procedure for modifying the mold becomes time-consuming and uneasy. Further, in some cases, modifying the mold involves more steps, which makes the development of a new product to delay seriously. Therefore, the conventional procedure of developing a mold cannot conform to the modern requirements for a high-speed development and cost-effectiveness.

In view of the above, the present Inventor proposes a novel and reasonable method to solve the above problems based on his expert knowledge and deliberate researches.

### SUMMARY OF THE INVENTION

The present invention is to provide a mold-making method capable of shortening a procedure of manufacturing a product mold, which can shorten the procedure of developing a mold and reduce the production cost of the mold.

The present invention provides a mold-making method capable of shortening a procedure of manufacturing a product mold, including steps of: (a) preparing a plastic original mold; (b) processing the original mold to form a preliminary product; (c) assembling the preliminary product and testing the functions of the preliminary product having the original mold; (d) producing a standard mold after testing the functions of the preliminary product; and (e) producing a final mold having a profile and a dimension corresponding to those of the standard mold.

The present invention provides a mold-making method capable of shortening a procedure of manufacturing a product mold, including a step of adding fibers in the original mold and injection-molding the original mold added with the fibers, thereby increasing the structural strength of the original mold.

In comparison with the conventional procedure for making a mold, the mold-making method of the present invention first produces an original mold having the same dimension and material as those of a desired final product by an injection molding process. Then, the original mold is preliminarily processed to generate a preliminary product whose inner and outer profiles correspond to those of the desired final product. Then, the preliminary product is tested with regard to desired functions, thereby determining whether the original mold has to be changed or finely-modified. Thereafter, the original mold is processed for the second time. After the secondly-processed original mold conforms to the requirements for functional test, the profile and dimension of the thus-made original mold are used to produce a standard mold. Then, the standard mold is used to produce a final mold. In this way, the problem that the mold has to be modified for several times can be solved. Therefore, the method of the present invention really shortens the procedure for manufacturing a mold and increases the effectiveness and practicability.

### BRIEF DESCRIPTION OF DRAWING

FIG. 1 is a schematic view showing the mold-making method capable of shortening a procedure of manufacturing a product mold in accordance with the present invention;

FIG. 2 is a schematic view showing an original mold of the present invention before being processed; and

FIG. 3 is a schematic view showing the original mold of the present invention after being processed.

### DETAILED DESCRIPTION OF THE INVENTION

The detailed description and technical contents of the present invention will become apparent with the following detailed description accompanied with related drawings. It is noteworthy to point out that the drawings is provided for the illustration purpose only, but not intended for limiting the scope of the present invention.

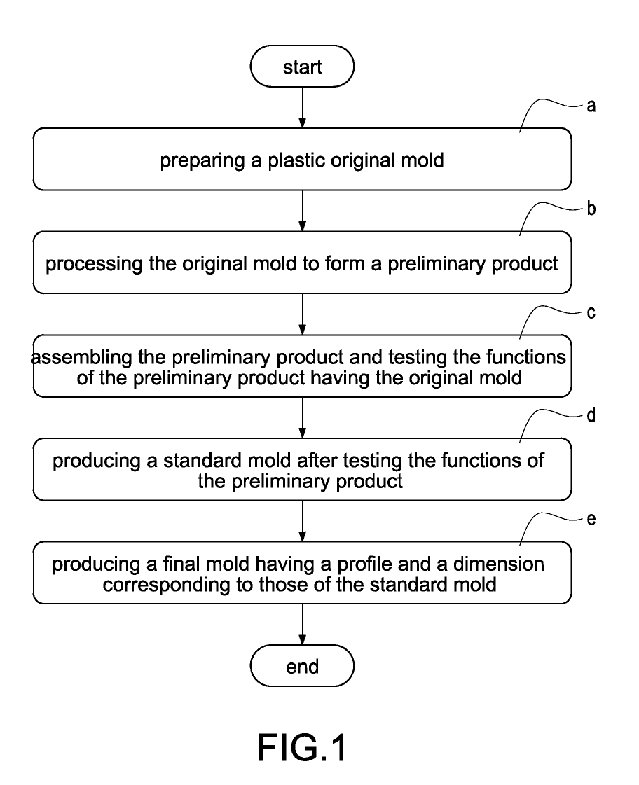

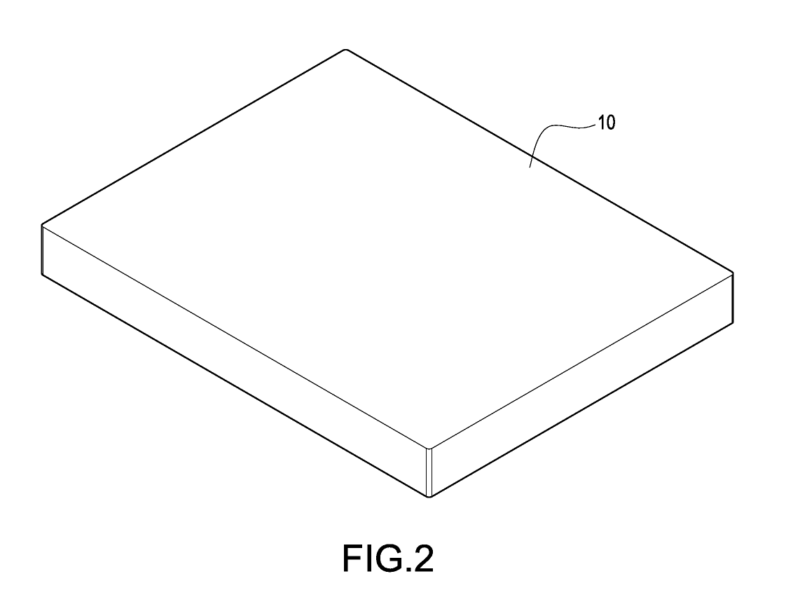

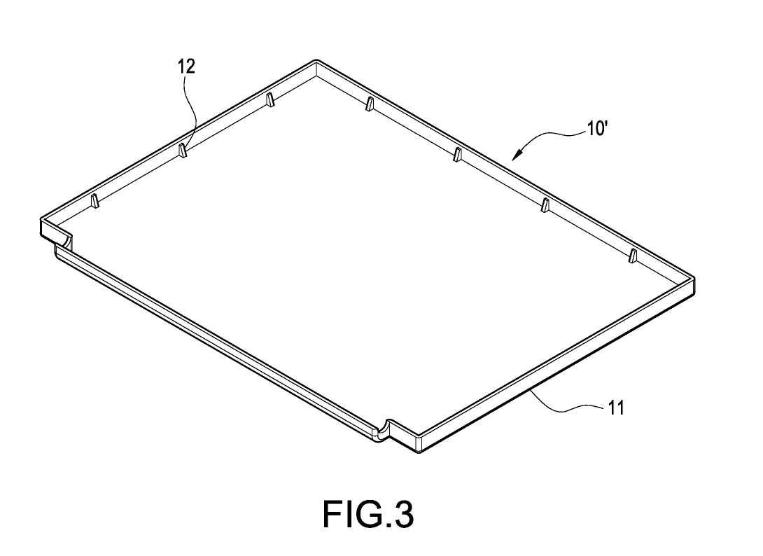

Please refer to FIGS. 1 to 3. FIG. 1 is a schematic view showing the mold-making method capable of shortening a procedure of making a product mold in accordance with the present invention. FIG. 2 and FIG. 3 are schematic views respectively showing the original mold of the present invention before being processed and after being processed. First, a plastic original mold 10 is prepared (step a). The original mold 10 is preliminarily processed to form a preliminary product (step b). The preliminary product is assembled and the preliminary product having the original mold 10 is tested with regard to desired functions (step c). Then, a standard mold 10′ is obtained after the functional tests (step d). That is, whether the original mold 10 is to be processed for the second time depends on the results of the functional tests. After the preliminary product conforms to the requirements for the functional tests, a final mold is produced based on the outer and inner dimensions of the standard mold 10′.

In the present embodiment, the material and dimension of the original mold 10 in the step (a) are substantially the same as those of a desired product. The original mold 10 is made by an injection molding process. The original mold 10 is made of polycarbonate (PC), acrylonitrile butadiene styrene (ABS) or nylon. Further, fibers may be added into the material of the original mold 10. Then, the mixed materials are subjected to an injection molding process to thereby increase the strength of the original mold 10.

Thereafter, the original mold 10 is processed by a computer numerical control (CNC) apparatus, a milling machine or an automatic lathe, thereby obtaining an outer profile 11 and an inner profile 12 of the original mold 10 for subsequent functional tests.

After finishing the preliminary processing of the original mold 10, a preliminary product is obtained. This preliminary product having the original mold 10 after being preliminarily processed are tested with regard to desired functions such as a falling test , a vibration test , an environmental test, an electromagnetic interference (EMI) test or the like.

According to the results of the functional tests, the original mold 10 may be processed for the second time to change or finely-modify the profile and dimension of the original mold 10. After the original mold 10 is processed for the second time and conforms to the requirements for the functional tests, the profile and dimension of the secondarily-processed original mold 10 are used to produce a standard mold 10′. Then, the standard mold 10′ is used to produce a final mold.

By means of the mold-making method of the present invention, the conventional procedure of modifying a mold can be reduced, so that the procedure of developing a mold can be also shortened to thereby decrease the production cost of a mold.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A mold-making method capable of shortening a procedure of manufacturing a product mold, including steps of:
(a) preparing a plastic original mold;
(b) processing the original mold to form a preliminary product;
(c) assembling the preliminary product and testing the functions of the preliminary product having the original mold;
(d) producing a standard mold after testing the functions of the preliminary product; and
(e) producing a final mold having a profile and a dimension corresponding to those of the standard mold.

2. The method according to claim 1, wherein the material and dimension of the original mold in the step (a) are substantially the same as those of a desired final product.

3. The method according to claim 1, wherein the original mold is produced in the step (a) by an injection molding process.

4. The method according to claim 1, wherein the original mold in the step (a) is made of any one of polycarbonate (PC), acrylonitrile butadiene styrene (ABS) or nylon.

5. The method according to claim 4, wherein the original mold in the step (a) comprises fibers.

6. The method according to claim 1, wherein the original mold is processed in the step (b) by any one of a computer numerical control (CNC) apparatus, a milling machine and an automatic lathe.

7. The method according to claim 1, wherein the preliminary product in the step (c) is subjected to any one of a falling test, a vibration test, an environment test and an electromagnetic interference test.
